(19) United States
(12) Patent Application Publication
(10) Pub. No.: US 2002/0012254 A1
(43) Pub. Date: Jan. 31, 2002

(54) Converter

(76) Inventors: Hubert Raets, Landgraaf (NL); Thomas Durbaum, Langerwehe (DE)

Correspondence Address: U.S. Philips Corporation, 580 White Plains Road, Tarrytown, NY, 10591, US

(21) Appl. No.: 09/908,203

(22) Filed: Jul. 18, 2001

(30) Foreign Application Priority Data
Jul. 19, 2000 (DE) 10035139.5

(51) Int. Cl. H02M 3/335

(52) U.S. Cl. 363/17

(57) ABSTRACT

The invention relates to a converter comprising

a full-bridge circuit comprising a first, second, third and fourth switching element (S1, S2, S3, S4), for converting a DC voltage (U_{Bat}) into an AC voltage (U_{˜});

a circuit (3) comprising at least a capacitive element (Cₛ) for coupling the full-bridge circuit to a converter output;

a control circuit (5) for controlling the switching elements (S1, S2, S3, S4) of the full-bridge circuit, a first mode being provided in which the full-bridge circuit is operated as a half-bridge circuit by a change of the switching states of the first and second switching elements (S1, S2) and the switching states of the third and fourth switching elements (S3, S4) are not changed, and a second mode being provided in which the full-bridge circuit is operated as a full-bridge circuit by a change of the switching states of all four switching elements (S1, S2, S3, S4).

Such a converter is suitable for use with different mains voltages of different AC voltage networks.

The invention relates to a converter for generating a DC voltage. Such converters are used, for example, in (switching) power supplies which convert an AC mains voltage into a DC supply voltage.

In the second revised edition of J. Wuistehube, Schaltnetzteile, see page 139, a bridge rectifier circuit for a switching power supply is discussed, which is used for converting an AC mains voltage into a DC voltage which, in its turn, is converted into a well-controlled DC supply voltage by means of a DC-DC converter. The bridge rectifier circuit comprises a switch-over device by means of which the bridge rectifier circuit is adapted to the respective available AC mains voltage (110 . . . 127 volts, for example, in the USA or 220 . . . 240 volts in Europe), so that the generated DC voltage has substantially the same values irrespective of the AC mains voltage present.

It is an object of the invention to provide a converter which is highly cost-effective and suitable for operation with different AC mains voltages of different AC voltage networks.

The object is achieved in that the converter comprises the following components:

a full-bridge circuit comprising a first, second, third and fourth switching element, for converting a DC voltage into an AC voltage;

a circuit comprising at least a capacitive element for coupling the full-bridge circuit to a converter output;

a control circuit for controlling the switching elements of the full-bridge circuit, a first mode being provided in which the full-bridge circuit is operated as a half-bridge circuit by a change of the switching states of the first and second switching elements and the switching states of the third and fourth switching elements are not changed, and a second mode being provided in which the full-bridge circuit is operated as a full-bridge circuit by a change of the switching states of all four switching elements.

By using the two modes, different ratios of DC output voltage to DC voltage can be set. The expenditure of components for the converter is kept at a minimum level. The modifications of a converter necessary for realizing the invention are concentrated, in essence, on the suitable realization of the control of the converter switching elements. The functions of the control circuit can easily be realized and with only little additional expenditure, more particularly, when the control circuit is realized by means of an integrated circuit (IC). The converter can keep the DC output voltage constant, especially when network voltages applied to the input are different. With the aid of this converter, however, it is also possible to set different ranges of the DC output voltage or the network voltage which remains the same.

Claim 2 relates to a possible variant of the invention in which the switching elements are switched on and off in pairs in the second mode. Each time two switching elements are switched on and off in synchronism then, so that the switch-on phases each time cover two switching elements (which also holds for the switch-off phases). Alternatively, for the second mode the switching elements could, for example, also be triggered when the switch-on phases of all four switching elements are in phase (in a so-termed phase-shifted PWM full bridge).

Claim 3 describes another embodiment. The switch-on and switch-off phases of the switching elements are kept approximately equally long in the two modes here (50:50-control), in this manner the ratio of DC output voltage to DC voltage in the second mode may be set approximately twice as large as in the first mode. The converter can, with the mains voltage of approximately 110 volts, for example in the USA, produce the same DC output voltage as in Europe which has approximately twice as large in mains voltage, while the second mode is used with the lower mains voltage and the first mode is used with the higher mains voltage. Preferably, an automatic change-over between the two modes is provided, as stated in claim 6, so that an automatic adaptation to different mains voltages takes place. More particularly, the DC voltage applied to the full-bridge circuit is evaluated for this adaptation i.e. applied to a respective control circuit. A direct evaluation of the mains voltage applied to the converter would, however, for example also be possible, in essence.

Claim 4 indicates the preferred embodiment of the converter as a resonant converter, which enables a minimization of the switching losses and a smaller design of the converter. A wide variety of variants of embodiment can be used here with one or various capacitive and one or more inductive elements. With the characteristic feature as claimed in claim 5, an often necessary potential separation of converter input and converter output is achieved.

An example of embodiment of the invention will be further explained with reference to the drawing Figures in which:

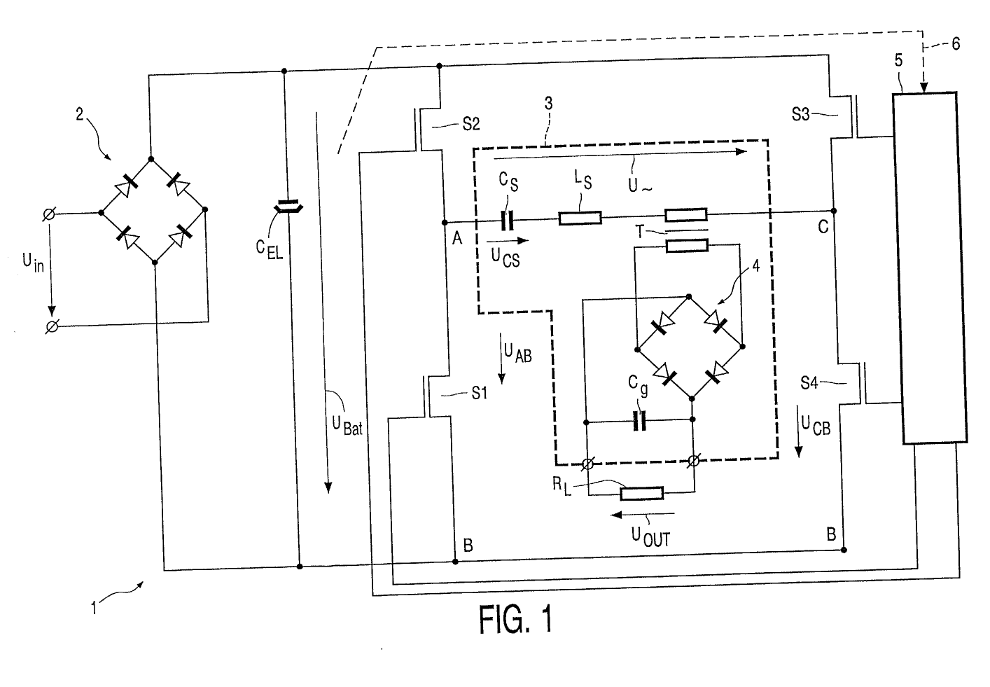

FIG. 1 shows a converter in accordance with the invention,

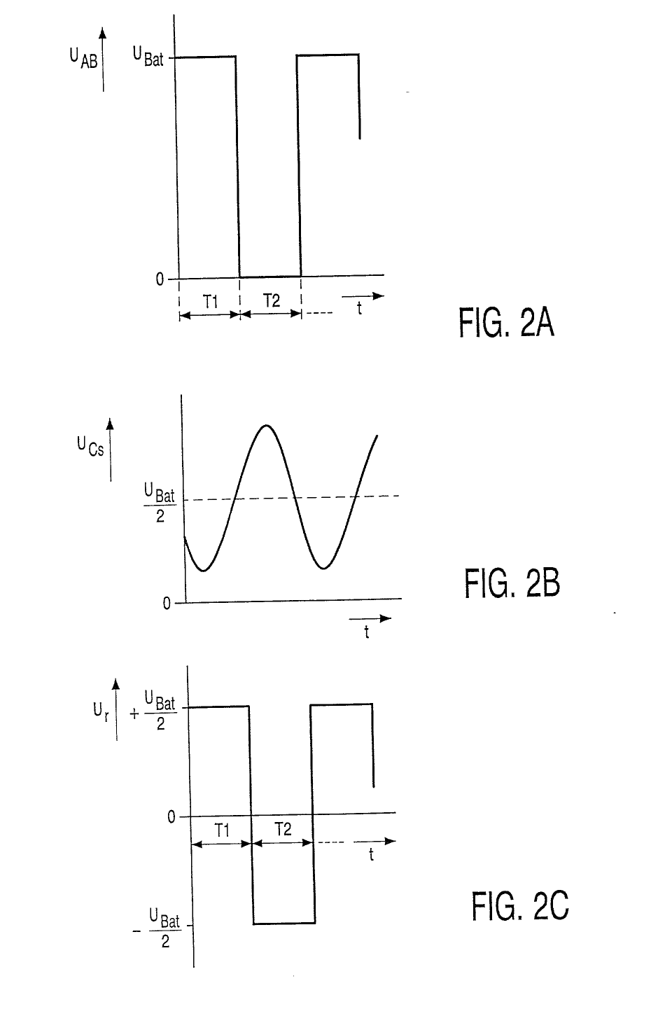

FIGS. 2A to 2C show voltage variations for a first converter switching mode and

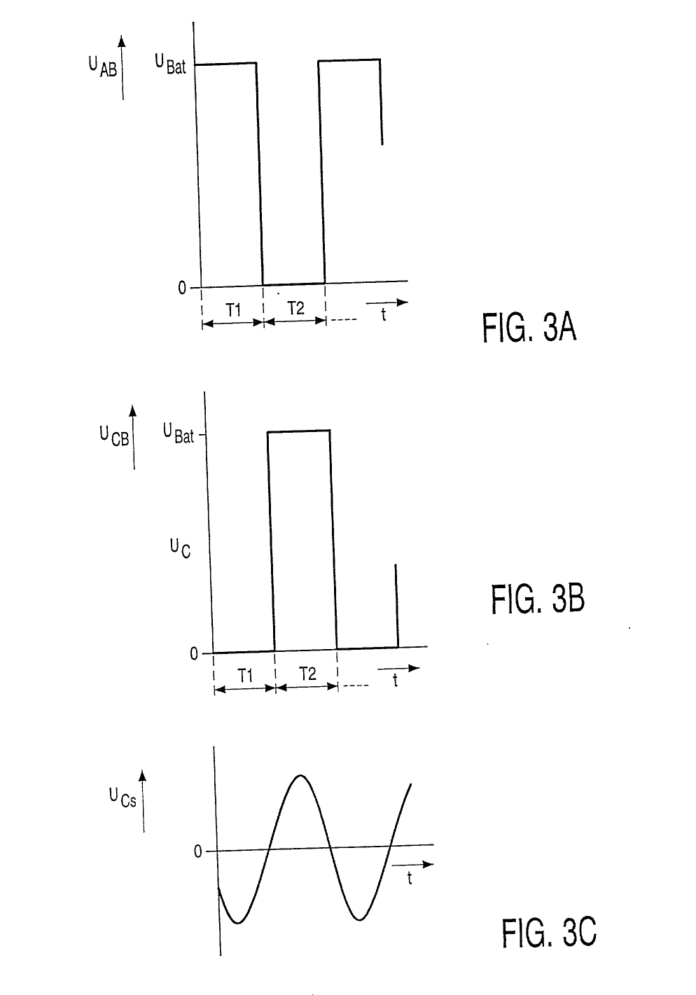

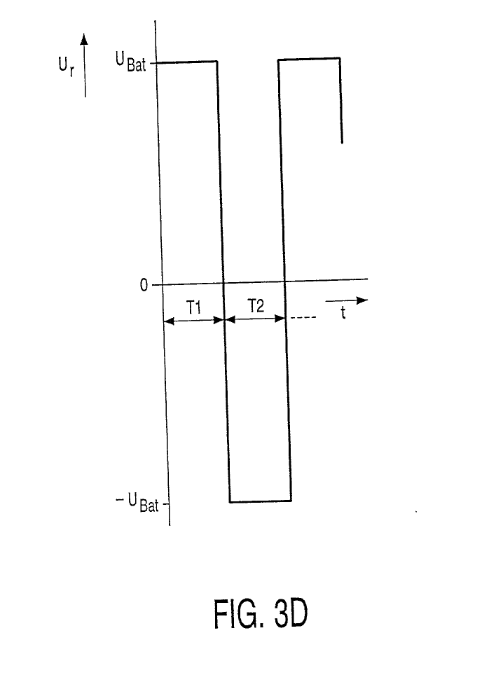

FIGS. 3A to 3D show voltage variations for a second converter switching mode.

FIG. 1 shows a converter 1 to whose input is applied an AC mains voltage Uᵢₙ, which is rectified by a bridge rectifier circuit 2 and subsequently smoothed by a smoothing capacitor C_{EL}. The DC voltage drop U_{Bat} consequently falling at the smoothing capacitor C_{EL} is applied to a full-bridge circuit, which comprises a first switching element S1, a second switching element S2, a third switching element S3 and a fourth switching element S4. The switching elements are here arranged as field effect transistors. The voltage U_{Bat} is applied both to the series combination of the two switching elements S1 and S2 and to the series combination of the two other switching elements S3 and S4, that is to say, the two series combinations of switching elements are connected in parallel to each other and are connected at a point B to each other and to a terminal of the capacitor C_{EL}. An AC voltage U_{˜}falling between a point A between the switching elements S1 and S2 and a point C between the switching elements S3 and S4, which AC voltage comes from chopping the voltage U_{Bat}, is applied to a circuit 3 on whose output, which is also the output of the converter 1, a DC output voltage V_{Out} is available, which is used for supplying power to a load R_{L}.

The circuit 3 comprises resonant circuit elements: here a capacitor Cₛ and an inductance Lₛ which form a series resonant circuit. The series circuit formed by the capacitor Cₛ and the inductance Lₛ is connected in series to a primary winding of a transformer T, which transformer T causes a potential separation between a converter input and a converter output. The series combination of capacitor Cₛ, inductance Lₛ and primary winding of the transformer T lies between the points A and C. A voltage falling at the secondary winding of the transformer T is rectified by means of a bridge rectifier circuit 4 and subsequently smoothed by a smoothing capacitor C_{g}. The voltage falling at the capacitor C_{g} is the DC output voltage U_{Out} available at the output of the converter 1.

The switching elements S1 to S4 are controlled by a control circuit 5 in that suitable control signals are applied to the control inputs of the switching elements i.e. switched on (brought to the conducting state) or switched off (brought to the non-conducting state) in a manner further explained with reference to the FIGS. 2A to 2C and 3A to 3D. The control circuit 5 then controls the switching elements S1 to S4 in two different modes which cause two different values of the ratio Uₒᵤₜ/U_{Bat} to occur and thus different values of the ratios Uₒᵤₜ/Uᵢₙ.

The control circuit 5 is preferably formed by an integrated circuit (IC) which may also comprise the four switching elements S1 to S4, where appropriate.

FIGS. 2A to 2C clarify the operation of the first mode. The switching element S3 is permanently switched off in this mode; the switching element S4 is permanently switched on in this mode, so that the voltage falling at the switching element S4 is equal to zero (short-circuit); basically, however, this could also be the other way round, i.e. the switching element S3 would then be permanently switched on and the switching element S4 would be permanently switched off. In this first mode the switching elements S1 and S2 are furthermore switched on and off alternately. The length of the on and off-phases is here substantially the same. This leads to a timing diagram of the voltage U_{AB} falling at the switching element S1 as shown in FIG. 2A. In time spaces T1 the switching element S1 is switched off and the switching element S2 is switched on, so that in these time spaces the voltage U_{AB} adopts the value of the voltage U_{Bat}. In time spaces T2, which alternate with the time spaces T1, the switching element S1 is switched on and the switching element S2 is switched off, so that the voltage U_{AB} is equal to zero in the time spaces T2.

During the operation of the converter 1 in the first mode, there is a variation of the voltage U_{cs} falling at the capacitance Cₛ of the resonant circuit, as shown in FIG. 2B. The voltage U_{cs} varies by the same amount by the one value of about U_{Bat}/². This corresponds to a variation of the voltage U_{˜} shown in FIG. 2 falling between the points A and C and then applied to the circuit 3. The voltage U_{˜} is directly derived from the voltage U_{AB} in that the DC component U_{Bat}/2 is subtracted from this voltage U_{AB}. The voltage U_{˜} in the first mode has an amplitude value U_{Bat}/2.

The second mode of operation of the converter is explained with reference to FIGS. 3A to 3D. In this mode the switching elements S1 to S4 are switched off and on in pairs. In the time spaces T1 the switching elements S1 and S3 are switched off and the switching elements S2 and S4 are switched on. In the time spaces T2 which—as already observed above—alternate with the time spaces T1, the switching elements S1 and S3 are switched on and the switching elements S2 and S4 are switched off. The thus resulting time diagram of the voltage U_{AB} (see FIG. 3A) is the same as in the first mode (compare FIG. 2A). However, the voltage U_{CB} falling at the switching element S4 is equal to zero only in the time spaces T1. In the time spaces T2 the voltage U_{CB} adopts the value U_{Bat}. The mode of operation causes a variation of the voltage U_{cs} on the capacitor Cₛ as shown in FIG. 3C. The voltage U_{cs} again has a swing-shaped variation, but without a DC component. The voltage U_{˜} appears from the difference U_{AB}-U_{CB} and has the variation shown in FIG. 3D. Compared to the voltage U_{˜} produced in the first mode shown in FIG. 2C, the amplitude is twice as large i.e. has the value U_{Bat} here. With the same mains voltage Uᵢₙ or the same voltage U_{Bat} respectively, there is twice as large a DC converter output voltage Uₒᵤₜ in the second mode.

More particularly, by means of the converter 1 according to the invention, an adaptation to different mains voltage ranges Uᵢₙ (for example for the mains voltages in the USA and in Europe differing approximately by a factor 2) may also be effected, so that despite the different mains voltages, the converter 1 produces the same constant DC output voltage Uₒᵤₜ which is used for supplying power to an electric appliance or a component of an electric appliance. The switch-over between the two described modes of operation particularly takes place automatically, while the control circuit is supplied with a signal corresponding to the current value of the voltage U_{Bat} (indicated by a dashed line 6) and the switching elements S1 to S4 are controlled in dependence on this signal in the above-described first or second mode. Preferably, the control circuit itself is supplied with the voltage U_{Bat} as shown in FIG. 1. However, also a control circuit could be provided which directly evaluates, for example, the mains voltage Uᵢₙ.

The invention is not restricted to the described embodiment of the converter 1. Deviations may include, for example, other arrangements of resonant circuit elements. Also different ratios T1/T2 (which may absolutely be variably adjustable during the operation of the converter) are conceivable for setting other ratios of Uₒᵤₜ to U_{Bat}. Furthermore, basically also pauses between two successive time spaces T1 and T2 are possible, in which pauses both the voltage U_{AB} and the voltage U_{CB} have the zero value in the second mode of operation of the converter.

Furthermore, a so-termed phase-shifted PWM full-bridge control of the four switching elements S1 to S4 may be effected for the second converter switching mode, so that in the second mode the switch-on phases of the switching elements S1 and S3, or the switching elements S2 and S4, respectively, are not connected in parallel but time-offset (in phase). Such a manner of operating a full-bridge circuit is known, for example, from Unitrode Power Supply Seminar, SEM-800, Bob Mammano and Jeff Putsch: “Fixed-Frequency, Resonant-Switched Pulse Width Modulation with Phase-Shifted Control”, September 91, pp. 5-1 to 5-7, more particularly from FIG. 1 with associated description. This document is herewith included in the application.

1. A converter comprising
a full-bridge circuit comprising a first, second, third and fourth switching element (S1, S2, S3, S4), for converting a DC voltage (U_{Bat}) into an AC voltage (U_{˜}),
a circuit (3) comprising at least a capacitive element (C_{S}) for coupling the full-bridge circuit to a converter output;
a control circuit (5) for controlling the switching elements (S1, S2, S3, S4) of the full-bridge circuit, a first mode being provided in which the full-bridge circuit is operated as a half-bridge circuit by a change of the switching states of the first and second switching elements (S1, S2) and the switching states of the third and fourth switching elements (S3, S4) are not changed, and a second mode being provided in which the full-bridge circuit is operated as a full-bridge circuit by a change of the switching states of all four switching elements (S1, S2, S3, S4).

2. A converter as claimed in claim 1, characterized in that in the second mode the switching elements (S1, S2, S3, S4) of the full-bridge circuit are alternately switched on and off in pairs.

3. A converter as claimed in claim 1 or 2, characterized in that
in the first mode the first and second switching elements (S1, S2) which are connected in series and are connected to the DC voltage (U_{Bat}) as a first series combination of switching elements are alternately switched on and off, while the voltage (U_{AB}) falling at the first switching element (S1) is applied as an AC voltage to the circuit (3) which includes the capacitive element, and
in the second mode the third switching element (S3), which is connected in series to the fourth switching element (S4), while the series combination of third and fourth switching elements (S3, S4) is connected to the DC voltage (U_{Bat}), is switched on and off in parallel to the first switching element (S1) and the fourth switching element (S4) is switched on and off in parallel to the second switching element (S2).

4. A converter as claimed in one of the claims 1 to 3, characterized in that the circuit (3) including the capacitive element is a resonant circuit.

5. A converter as claimed in one of the claims 1 to 4, characterized in that a transformer (T) is provided for separating the potential between AC voltage (U_{˜}) and DC output voltage (Uₒᵤₜ).

6. A converter as claimed in one of the claims 1 to 5, characterized in that an automatic change-over is provided between the two modes in dependence on the DC voltage (U_{Bat}).

7. An integrated circuit comprising the control circuit (5) of the converter as claimed in one of the claims 1 to 6.

8. An integrated circuit as claimed in claim 7, which also includes the four switching elements (S1, S2, S3, S4) of the full-bridge circuit of the converter as claimed in one of the claims 1 to 6.
